(19) United States
(12) Patent Application Publication
(10) Pub. No.: US 2012/0127980 A1
(43) Pub. Date: May 24, 2012

(54) Wireless Network Notification, Messaging and Access Device

(76) Inventor: Kenneth Ray Quinn, Saskatoon (CA)

(21) Appl. No.: 13/301,766

(22) Filed: Nov. 21, 2011

Related U.S. Application Data
(63) Continuation-in-part of application No. 12/192,998, filed on Aug. 16, 2008, now Pat. No. 8,078,160.
(60) Provisional application No. 60/956,678, filed on Aug. 17, 2007.

(51) Int. Cl. H04W 4/02

(52) U.S. Cl. 370/338

(57) ABSTRACT

Disclosed is the transmission of data other than an identification of the wireless network (non-network id data) in a network identification field (NIF) of a wireless frame. The wireless transmitting device (Tx) may generate a wireless frame according to a network protocol and place a representation of the data in the NIF of the frame. The Tx may insert in the frame an indication that the data is non-network id data and transmit the frame over a wireless network according to the network protocol. The indication may be provided by the values of one or more fields of the frame. The receiving device may recognize that the NIF contains non-network id data and may extract the data from the NIF.

Pursuant to 35 USC §120, this continuation application claims priority to and benefit of U.S. Utility patent application Ser. No. 12/192,998, filed Aug. 16, 2008, on behalf of inventor Kenneth R Quinn, entitled “WIRELESS NETWORK NOTIFICATION, MESSAGING AND ACCESS DEVICE.” That application in turn claims priority to and benefit of Provisional Application Sr. No. 60/956,678 filed on Aug. 17, 2007. Accordingly, this continuation application also claims priority to and benefit of Provisional Application Sr. No. 60/956,678.

### BACKGROUND

The present disclosure relates generally to wireless technologies. More particularly, the present disclosure relates to using a network identification field of a wireless frame for the transmission of data.

Digital data may be sent over a network according to protocols, or agreements on how to format the data in the transmissions. The data may be sent in units called frames or packets. Frames or packets transporting digital data may contain a field or fields which identify the network (network identification fields). In some protocols, the length of this field may vary between certain limits. In other protocols, the length of this field may be fixed.

Wireless networks include wireless local area networks (WLANs). WLANs in common use include a station device (STA) and an access point (AP). The STA's associate with an AP to receive connectivity to a local area network (LAN) and/or the Internet. The protocols used for these connections may be described in IEEE 802.11x specifications or protocols. These documents describe a wireless LAN Medium Access Control (MAC) layer which includes a service set identifier (SSID). An SSID identifies the LAN. The length of an SSID may vary from a minimum of 0 octets (groups of 8 bits) up to a maximum of 32 octets.

An IEEE 802.11x specification or protocol is a WLAN standard published by the IEEE, a professional organization made up of companies in the computer industry. The standards may include, but are not limited to, 802.11 (2007), 802.11k (2008), 802.11n (2009), 802.11p (2010), 802.11r (2008), 802.11u (2011), 802.11v (2011), 802.11w (2009), 802.11y (2008), and 802.11z (2010) and may include WLAN standards published by IEEE in the future.

On power up, a STA in a WLAN will scan for beacon signals from an AP or will send a probe request signal. A beacon frame may be a periodic frame to announce the presence of the network. STA may transmit a probe request signal to obtain information about the presence of networks, such as which access points are within range.

APs in range of the probe request will respond with a probe response signal. If the SSID of the STA is authorized by the AP and further association requirements such as a shared network key are met, then authentication can be completed and the STA receives access to the LAN or Internet. Authentication is verification of the identity of the sender of a message. Some forms include placing in the message a secret known only to the sender, such as a security key, or encrypting a signature with a key known only to the sender. This operation of a WLAN as described in IEEE 802.11x documents is widely used throughout the world today. It provides for association, authentication and network access for WLAN devices.

### SUMMARY

This application discloses hardware and/or code to transmit data in a network identification field (NIF) of a wireless frame. A wireless transmitting device may obtain data directly through sensors or other components, by reading it from memory, or by receiving data from another device. The wireless transmitting device may generate a wireless frame according to a network protocol and place a representation of the data in the network identification field of the wireless frame. The wireless transmitting device may also insert in the frame an indication that the data is encoded in the NIF of the frame, and transmit the frame in a wireless communication over a wireless network according to the network protocol. The data may be data other than an identification of the wireless network. The indication may be provided by the values of one or more fields of the frame. In many embodiments, the indication may be inserted pursuant to a standard wherein data other than an identification of a network is contained in an NIF of a frame transmitted under the network protocol.

### BRIEF DESCRIPTION OF THE DRAWINGS

FIG. 1 depicts an embodiment of wireless devices communicating data in an SSID according to IEEE 802,11x specifications over a first wireless network;

FIG. 2 depicts a further embodiment of wireless devices communicating data in an SSID according to IEEE 802,11x specifications over a first wireless network;

FIG. 3 depicts an further embodiment of wireless devices communicating data in an SSID according to IEEE 802,11x specifications, wherein a wireless receiving device has access to a network other than the over a first wireless network;

FIG. 4 depicts an further embodiment of wireless devices communicating data in an SSID according to IEEE 802,11x specifications, wherein a first wireless device transmits data in an SSID to a second wireless device, the second wireless device receives the data and transmits data based upon the received data to a third wireless device, wherein the third wireless device has access to another network;

FIG. 5 depicts an further embodiment of wireless devices communicating data in an SSID according to IEEE 802,11x specifications, wherein a first wireless receiving device transmits data to a second wireless receiving device in a SSID over a first wireless network and wherein the second wireless receiving device has access to a network other than the first wireless network; and

FIG. 6 illustrates a flow chart of an embodiment for communicating data in a NIF of a wireless frame.

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

Generally, wireless network notification messaging and access devices are described herein. Embodiments may comprise logic such as hardware and/or code to transmit data in a network identification field (NIF) of a wireless frame. A wireless transmitting device may obtain data directly through sensors or other components, by reading it from memory, or by receiving data from another device. The wireless transmitting device may generate a wireless frame according to a network protocol and place a representation of the data in the network identification field of the wireless frame. The wireless transmitting device may also insert in the frame an indication that the data is encoded in the NIF of the frame, and transmit the frame in a wireless communication over a wireless network according to the network protocol. The data may be data other than an identification of the wireless network. The indication may be provided by the values of one or more fields of the frame. In many embodiments, the indication may be inserted pursuant to a standard wherein data other than an identification of a network is contained in an NIF of a frame transmitted under the network protocol. A standard may consist of a set of rules adopted by a group of people which regulate data transmission between computers. Some standards may be promulgated by official standards bodies, organizations with members from many companies in the computer industry which published standards generally accepted by the industry. In some cases, a single company may adopt a format for communicating between various devices of the company. A company may, for instance, manufacture a wireless transmitting device connected to a sensor and transmit sensor readings through the wireless transmitting device to a wireless receiving device according to a proprietary format of the company's. That format may also constitute a standard.

A wireless receiving device may receive the wireless frame, recognize the network identification field as containing data, and process the data. The processing may include forwarding the data to another device, either over the same wireless network or another network. In some embodiments, when the network identification field is variable length, the wireless receiving device may recognize that the network identification field contains data through the length of the network identification field. The wireless transmitting device and wireless receiving device may operate according to a protocol or standard under which a network identification field of a particular length signals that the field is used to transmit data.

In many further embodiments, the network identification field may consist of the Service Set Identifier (SSID) of a transmission according to an 802.11x protocol. In some of those embodiments, the agreed-upon length may consist of 32 octets, the maximum permissible length of an SSID. In other embodiments, other parameters of the wireless frame may indicate that the network identification field is to be interpreted as containing data. As an example, a destination address may be encoded with all 0's or all 1's but the last bit. As another example, a special value may be inserted in some little-used field or an optional field of an SSID might be used to indicate that network identification field is to be interpreted as containing data.

Many kinds of data may be encoded in the network identification field. One type of data may consist of monitoring information—the output of sensors monitoring the state of a machine or an environment. As examples, the data may indicate that a home alarm has been triggered or that a light has been turned on, the temperature of a room, the usage of a utility such as water or gas, or the amount of product in a vending machine. Another type of data may consist of identification information. The information may indicate the identity of the transmitting device or a user of the transmitting device. A third type of data may describe the location of a user. A fourth type of data may consist of a command. A user may send a command to turn on a home air-conditioner or turn on an oven. In some cases, the network identification field may contain multiple types of data. A portion may, for example, identify a user, another portion may identify a household appliance, and the remainder may contain a command for the household appliance.

In some embodiments, the wireless receiving device may trigger an action based upon the received data. For example, the wireless receiving device may open a gate or unlock a door upon authentication of the sender based on the received data. In other embodiments, the wireless receiving device may relay the data to another device. The device may, for example, receive data indicating that a home alarm has been triggered and send a message to a home security service or may receive data indicating that a vending machine is low on a certain product and send the information to a supplier of the vending machine. In further embodiments, a succession of devices may relay the data, thereby forming a mesh network (a network in which peer nodes relay a message from one device to another until the message reaches a desired destination). In yet other embodiments, the wireless receiving device may be connected to another network, such as the Internet. Upon receiving the data, it may connect the wireless transmitting device to the other network. For example, the data in the network identification field may identify the user or the device. Upon authenticating the user by means of the data and perhaps additional data contained in the frame, the wireless receiving device may then grant the wireless transmitting device access to the other network. As one specific example, the wireless receiving device may connect a smart phone to the Internet to enable VoIP from the smart phone without requiring action on the user's part to connect to the Internet.

In some embodiments, a wireless transmitting device may be simple in form, with very little radio-frequency (RF) capabilities. It may be constructed to obtain data, such as monitoring data, and send out beacons or probe request signals which include the data in a network identification field. The wireless transmitting device may transmit only those frames and no other frames. Further, it may lack wireless receiving capabilities, except as needed to obtain monitoring data from sensors. The transmitting devices may not need to actually connect to the 802.11 WIFI network, to authenticate data, or to receive or reply to 802.11 signals. As such, these transmitting devices may be inexpensive to manufacture, as they would only need capabilities to send an 802.11 SSID beacon.

In a very basic means, an integrated circuit would only need to transmit an 802.11 SSID beacon when it is powered up. In some embodiments, where the content remains constant, the SSID may be programmed at the factory to identify the unit. For example, a door contact switch may be programmed to be identified with a fixed SSID. An alarm system could utilize the door contact switch to send WiFi to its contacts.

More generally, such a simple device may receive monitoring data from one or more sensors, encode the monitoring data in NIFs of frames under some network protocol, and transmit the frames. The simple devices need not engage in conversations under the network protocol to establish connections, and need not receive and reply to messages under the network protocol, or otherwise to respond to messages. In some embodiments, these simple devices may even lack receiving capabilities for wireless transmissions. In other embodiments, they may receive the monitoring data from the sensors through wireless transmissions.

For example, a simple RF device attached to a home alarm system may send only an 802.11 beacon signal. When the home alarm system is activated, the device may power up and send the 802.11 SSID in a beacon. A neighbour's receiver may pick up the beacon and send the SSID to a server for the home alarm system. The devices have no need to connect to the receivers or act as receivers themselves. An example may be a transmitter connected to a button near a bottled water fountain. When the water bottle is running out, the button is pressed, sending the 802.11 SSID to the nearest receiver. When the water has been delivered the button can be pressed again signifying a full bottle.

In other embodiments, the wireless transmitting device may be capable of other communications. A smart phone may, for example, transmit a frame identifying itself in order to be connected to the Internet through a laptop or tablet. In addition, one cell phone or other wireless device may relay data contained in a network identification field to another similar device in a form of mesh network.

While some of the specific embodiments described below will reference the embodiments with specific configurations, those of skill in the art will realize that embodiments of the present disclosure may advantageously be implemented with other configurations with similar issues or problems.

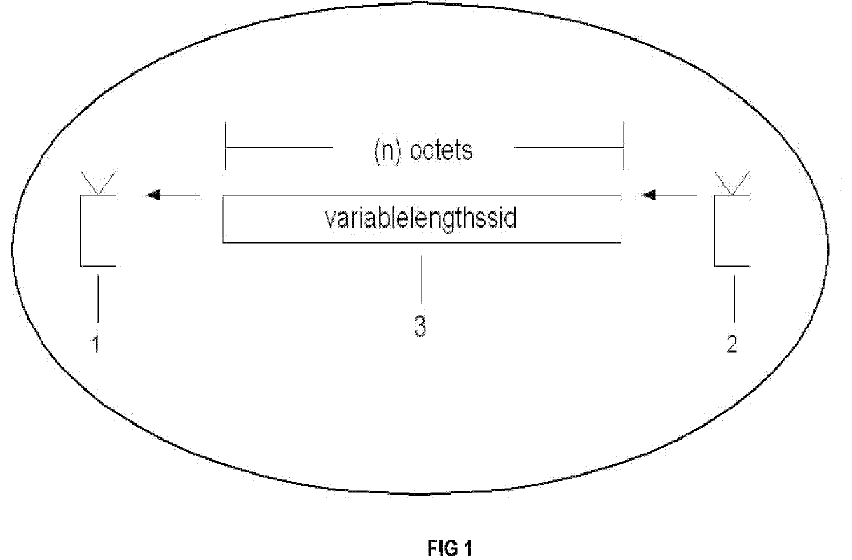

Turning now to FIG. 1, there is shown an embodiment of a wireless system for communicating data other than the identification of the network in a network identification field. In the wireless system of FIG. 1, the wireless devices 1 and 2 may communicate according to an 802.11x protocol and may have adopted a further standard or convention that the SSID field is to be used for data other than the identification of the network. The wireless receiving device 1 may receive signals from in-range wireless transmitter 2. In some embodiments, the wireless transmitter 2 may be sending either a probe request or a beacon signal. The probe request is normally sent by a Station (STA) and the beacon signal is usually sent by an Access Point (AP), but according to the IEEE 802.11x specifications both send the Service Set Identifier (SSID) 3 so as to identify a compatible device. It makes no difference if an AP is used as a transmitting STA because the wireless receiving device 1 is listening for the SSID with no regard to the type of wireless transmitting device 2. In other embodiments, the wireless transmitter 2 may be sending another type of 802.11x frame.

In the embodiment of FIG. 1, the signal from wireless device 2 to wireless device 1 may contain SSID 3 with length n octets, where n is a fixed positive integer less than or equal to 32. The IEEE 802.11x specifications allows for a 0 to 32 octet SSID. In the embodiment of FIG. 1, the wireless receiving device 1 recognizes that the transmitting device 2 has included data in the SSID field by the length of SSID 3 of n octets. It should be noted that any IEEE 802.11x compliant transmitting device in range can send to wireless receiving device 1a signal containing an SSID but wireless receiving device 1 may recognize or treat only an SSID containing exactly n octets as containing data other than the network identification. The frame containing SSID 3 may contain a field indicating the length of the SSID contained in the frame. In case n=32, SSID 3 is called a maximum set SSID. When the data is shorter than n octets, a standard or convention may call for padding the SSID with leading or following zeros (or ones).

In some embodiments of FIG. 1, wireless device 2 may be an end use device. An end use device may have a primary purpose other than communications, such as controlling the operation of an appliance or appliances or monitoring the operation of another device. An end use device may, for example, be a device that initially obtains the data being transmitted in the network identification field. The end use device may, for example, be connected to or directly communicate with a sensor to monitor the state of a machine or an environment. The end use device may include an integrated circuit including a micro-controller receiving information from a vending machine, utility meter, home/commercial security alarms, personal safety/health devices, personal/object locating, presence, instant messaging, web access, VoIP, utility meter reading, product level tracking such as vending machines, etc. The sensor may, for example, detect that a home alarm has been triggered or that a light has been turned on, or may indicate the temperature of a room. The end use device may also include an RF chip with a WIFI driver that sends a WIFI SSID with content. Alternatively, wireless device 2 may have received the data encoded in SSID 3 over a network and relay the data to wireless device 1, over the same network or over another network.

In further embodiments of FIG. 1, wireless device 2 may constitute a stripped-down device that merely broadcasts, using the SSID to transmit data, but does not send other types of frames or follow the steps of a communications protocol to establish a connection with another wireless device.

In some embodiments, wireless device 1 may relay the data encoded in SSID 3 to another device. For example, wireless device 1 may relay the data over the same network to another wireless device. The wireless devices may comprise a mesh network, an arrangement of peer nodes (nodes which perform similar functions) which relay data from one node to another until they reach the desired destination. Alternatively, wireless device 1 may relay the data over a different network. Wireless device 1 may, for example, be connected to the Internet and may relay the data to an application which uses the data.

In other embodiments, wireless device 1 may not forward the data. Instead, wireless device 1 may itself constitute an end use device, and may perform an action based upon the data. Wireless device 1 may, for example, consist of an electronic gate or garage door which opens upon receipt of an SSID containing an identification of an authorized person. As another example, wireless device 1 may consist of a control for a home appliance such as an oven, a furnace, or an air conditioner. Upon receipt of data encoded in SSID 3, wireless device 1 may issue a command to the home appliance. In some further embodiments, the data may include an identification of a user and a command related to an appliance, such as “turn on the air conditioner.” Upon receipt of the data and verification of the user as an authorized user, wireless device 1 may turn on an air conditioner.

In various embodiments of FIG. 1, SSID 3 may contain several types of data. One type of data may consist of monitoring information—the output of sensors monitoring the state of a machine or an environment. As examples, the data may indicate that a home alarm has been triggered or that a light has been turned on, or may indicate the temperature of a room. Another type of data may consist of identification information. The information may indicate the identity of the transmitting device or a user of the transmitting device. For example, a receiving device may authorize a transaction or access based upon the identification of the transmitting device or the user. A third type of data may describe the location of a user. A fourth type of data may consist of a command. A user may send a command to turn on a home air-conditioner or turn on an oven. In some cases, the network identification field may contain multiple types of data. A portion may, for example, identify a user, another portion may identify a household appliance, and the remainder may contain a command for the household appliance.

In some embodiments, the SSID 3 may contain the complete substance of the message of the 802.11x frame. Wireless device 1 may examine other fields of the frame to verify that the frame is a proper 802.11x frame and that SSID 3 is indeed a proper SSID, but may not otherwise respond to the frame based upon the contents of the other fields. In other embodiments, other fields of the 802.11x frame may also contain a portion of the substance of the message. For example, wireless device 1 may authenticate the message based upon the SSID 3 and based upon other fields, such as the MAC address, which may identify wireless device 2.

In an embodiment of FIG. 1, wireless transmitting device 2 may constitute an ankle monitor, a device attached to the ankle that transmits a radio frequency signal containing location and other information. The device may be tamper-resistant and attached to a criminal offender. The ankle monitor may include a small WIFI transmitting device that transmits a WIFI beacon signal of length n octets at regular intervals. The signal may contain an identifier and may be received by a WIFI receiver that monitors n-octet WIFI signals. The receiver may use the encoded identifier to obtain identification and particulars of the individual from a networked database. A practical example of this system would be convicted shoplifters having attached ankle monitor with a WIFI transmitter and retail businesses having WIFI receivers. When a shoplifter enters a retail store, the shoplifter is identified and the staff is alerted to the shoplifter's presence, either to refuse service or monitor his behavior. Other similar scenarios with a variety of criminals could be envisioned so that families could be actively notified of criminal presence outside their homes or in their neighborhood.

In another embodiment of FIG. 1, wireless transmitting device 2 may constitute a smart phone device of a user. When the user with the smart phone approaches a locked door, the smart phone may transmit an SSID of n-octets. Wireless receiving device 1 may constitute a receiving device in the door lock mechanism which recognizes the n-octet SSID transmission as containing data in the SSID field. Wireless receiving device 1 may verify that the user is authorized to enter and activate the door lock mechanism to allow the user to enter through the door.

In another embodiment of FIG. 1, wireless transmitting device 2 may constitute a transmitting device in a truck. Wireless receiving device 1 may constitute a receiving device in an electric gate mechanism which recognizes the n-octet SSID transmission as containing data in the SSID field. Wireless receiving device 1 may verify that the user is authorized to enter. Upon authorization, the electric gate mechanism may activate, opening the gate and allowing the truck to pass through.

The wireless system illustrated in FIG. 1 is for explanation, not for limitation. Wireless systems transmitting data other than the identification of the network in a network identification field according to various embodiments of the present invention may operate under protocols other than 802.11x protocols and may indicate that the network identification field contains data in ways other than the length of the network identification field. In some embodiments, for example, the contents of another field or fields of the wireless frame may indicate that the network identification field is used for data other than the identification of the network. Some embodiments may include additional components. Wireless device 2 may, for example, send data in a network identification field to multiple other wireless devices or wireless device 1 may relay the data, either through wireless communications or through other means of communications.

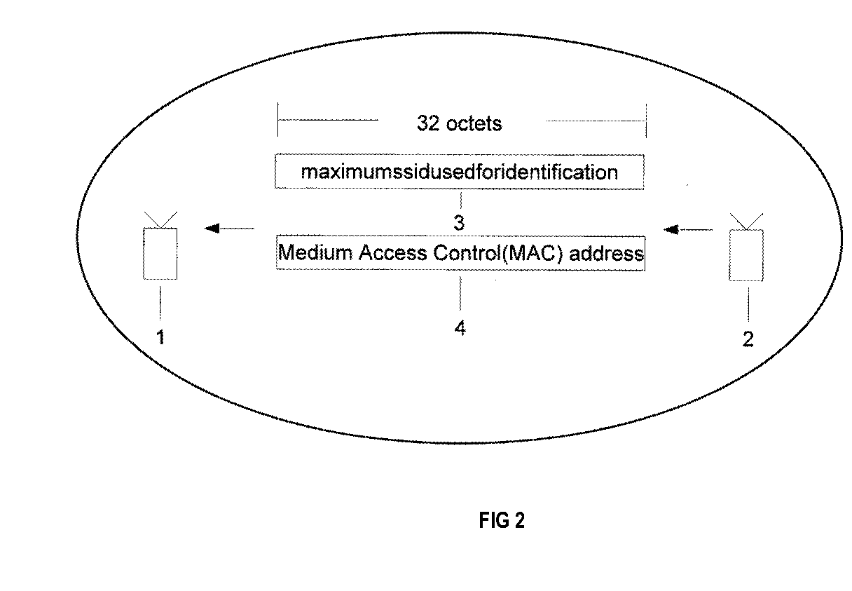

FIG. 2 provides an additional embodiment of a wireless system for communicating data other than the identification of the network in a network identification field. The wireless receiving device 1 may receive signals from in-range wireless transmitter 2. In some embodiments, the wireless transmitter 2 may be sending either a probe request or a beacon signal.

In the wireless system of FIG. 2, the wireless devices 1 and 2 may communicate according to an 802.11x protocol and may have adopted a further standard or convention that the SSID field is to be used for data other than the identification of the network. In the embodiment of FIG. 2, the wireless receiving device 1 recognizes that the transmitting device 2 has included data other than the identity of the network in the SSID field by the length of SSID 3. In the embodiment of FIG. 2, SSID 3 is a maximum set SSID with length 32 octets. In the embodiment of FIG. 2, in addition to utilizing the data contained in SSID 3, the wireless receiving device 1 also utilizes the data contained in Medium Access Control (MAC) address 4. It is to be understood that the MAC address is unique to the transmitting device 2, allowing wireless receiving device 1 to firstly identify the transmitting device 2 as a maximum set SSID transmitting device and further recognize the transmitting device specifically by its MAC address 4. The MAC field may be used for security in identifying a sender as it may require some effort to change it. In addition, location information from the MAC might provide useful input to an application. A home security alarm may, for example, use a central monitoring station which contains a data base of street address of its customers indexed with MAC address. A stationary WIFI router (which in this case is the receiving device) connected to the Internet may receive the MAC of a door sensor (transmitter) and pass it along to a monitoring station which would identify where the security breach occurred.

The maximum set SSID 3 can be any combination of ASCII characters. It is not necessary for the wireless receiving device 1 to have any knowledge of the contents of the SSID 3. This allows for a vast network of transmitters to securely access and function with the wireless receiving device 1. It also allows for a key to be placed in the SSID 3 of the wireless transmitter 2 restricting unlawful access.

In further embodiments, wireless receiving device 1 may comprise an end use device. Upon receipt of the frame containing SSID 3 and MAC address 4, wireless receiving device 1 may perform some action such as opening a gate or modifying the controls of a home appliance.

The wireless system illustrated in FIG. 2 is for explanation, not for limitation. Wireless systems transmitting data other than the identification of the network in a network identification field according to various embodiments of the present invention may operate under protocols other than 802.11x protocols and may indicate that the network identification field contains data in ways other than a maximum set SSID. In some embodiments, for example, the contents of another field or fields of the wireless frame may indicate that the network identification field is used for data other than the identification of the network. Some embodiments may include additional components. Wireless device 2 may, for example, send data in a network identification field to multiple other wireless devices or wireless device 1 may relay the data, either through wireless communications or through other means of communications. In some embodiments, fields other than the MAC address field may contain information used by wireless receiving device 1.

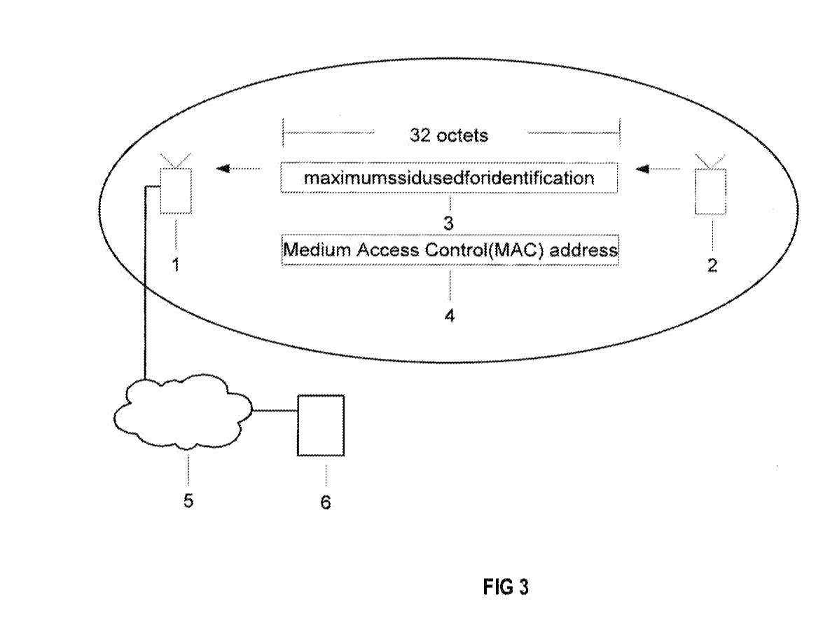

Turning now to FIG. 3, there is shown an additional embodiment of a wireless system for communicating data other than the identification of the network in a network identification field. In the wireless system of FIG. 3, the wireless devices 1 and 2 may communicate according to an 802.11x protocol and may have adopted a further standard or convention that the SSID field is to be used for data other than the identification of the network. The wireless receiving device 1 may receive signals from in-range wireless transmitter 2. In some embodiments, the wireless transmitter 2 may be sending either a probe request or a beacon signal. In other embodiments, the wireless transmitter 2 may be sending another type of 802.11x frame. In the embodiment of FIG. 3, the wireless receiving device 1 recognizes that the transmitting device 2 has included data other than the identity of the network in the SSID field by the length of SSID 3. In the embodiment of FIG. 3, SSID 3 is a maximum set SSID with length 32 octets. In the embodiment of FIG. 3, in addition to utilizing the data contained in SSID 3, the wireless receiving device 1 also utilizes the data contained in Medium Access Control (MAC) address 4.

In the embodiment of FIG. 3, the wireless receiving device 1 having connectivity to the Internet 5 gains access to server 6. In one embodiment of the present invention the wireless receiving device 1 receives maximum set SSID 3 and MAC address 4 from wireless transmitting device 2. In response, wireless receiving device 1 may send a message over the Internet 5 to server 6. In some embodiments, the message may consist simply of relaying or forwarding the contents of maximum set SSID 3 and MAC address 4. Server 6 may be able to identify wireless transmitting device 2 by its unique MAC address 4. It also has 32 octets of content in maximum set SSID 3 which can be used for security purposes and data reception.

In other embodiments, the message to server 6 may be based upon the contents of maximum set SSID 3 and MAC address 4. As an example, SSID 3 and MAC address 4 may constitute a security key and a report from an end use device with MAC address 4 that a certain vending machine is low on a certain product. In response, wireless receiving device 1 may send a message over the Internet 5 to server 6 requesting the delivery of a certain amount of the product to a certain physical address.

One practical example of the embodiment of FIG. 3 may consist of a wireless transmitting device 2 connected to a home security alarm. When the home security alarm is activated, the wireless transmitting device 2 may send a probe request signal including maximum set SSID 3 and MAC address 4. This information may be received by wireless receiving device 1 and sent over the Internet 5 to Server 6. Server 6 may identify the location of the alarm signal using MAC address 4 and content of maximum set SSID 3 and may utilize said content for information such as type of alarm (smoke, burglar, low temperature etc.) and zone of activation. Server 6 may then take the appropriate action as necessary such as alerting resident, police, emergency services etc.

It must be noted that in the embodiment of FIG. 3, wireless receiving device 1 need not be located at the same premise as wireless transmitting device 2, allowing for a neighbor with wireless transmitting device 1 to receive signals from wireless transmitting device 2. This effectively prevents telephone wire cutting from stopping signals reaching a monitoring station.

In another embodiment of FIG. 3, wireless transmitting device 2 may consist of an ankle monitor. Wireless receiving device 1 may transmit data obtained from the ankle monitor to server 6, enabling a central data base to monitor a criminal offender. For example, wireless receiving device 1 may be a Wi-Fi receiver at a department store and server 6 may constitute a central server. When wireless receiving device 1 alerts server 6 to the presence of a criminal offender, server 6 may trigger an alarm.

The wireless system illustrated in FIG. 3 is for explanation, not for limitation. Wireless systems transmitting data other than the identification of the network in a network identification field according to various embodiments of the present invention may operate under protocols other than 802.11x protocols and may indicate that the network identification field contains data in ways other than a maximum set SSID. In some embodiments, for example, the contents of another field or fields of the wireless frame may indicate that the network identification field is used for data other than the identification of the network. In some embodiments, wireless device 1 may relay the data through a network other than the Internet and the recipient of the data may be other than a server. In some embodiments, fields other than the MAC address field may contain information used by wireless receiving device 1.

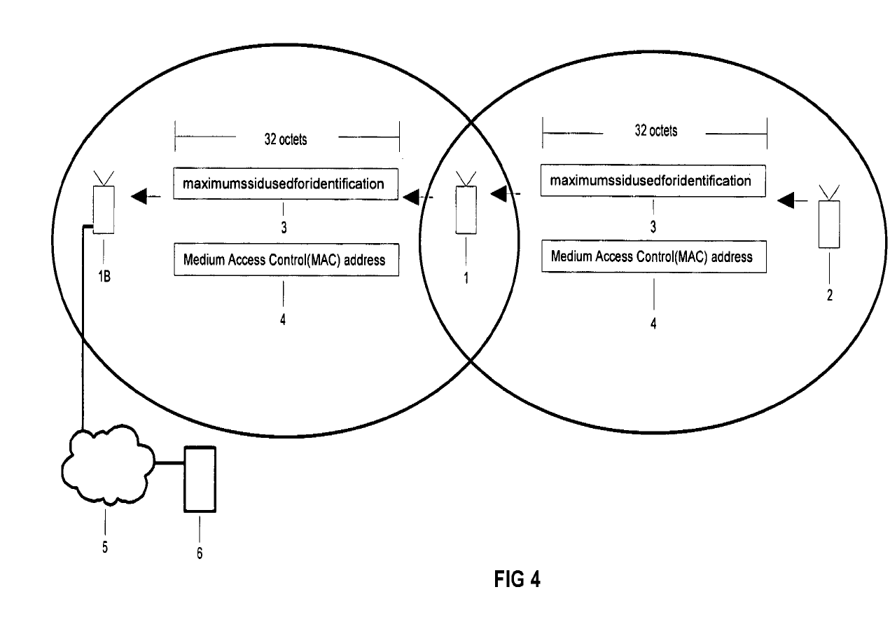

With reference now to FIG. 4, there is shown an additional embodiment of a wireless system for communicating data other than the identification of the network in a network identification field. In the wireless system of FIG. 4, the wireless devices 1, 1B, and 2 may communicate according to an 802.11x protocol and may have adopted a further standard or convention that the SSID field is to be used for data other than the identification of the network. The wireless receiving device 1 may receive signals from in-range wireless transmitter 2. In some embodiments, the wireless transmitter 2 may be sending either a probe request or a beacon signal. In other embodiments, the wireless transmitter 2 may be sending another type of 802.11x frame. In the embodiment of FIG. 4, the wireless receiving device 1 may recognize that the transmitting device 2 has included data other than the identity of the network in the SSID field by the length of SSID 3. In the embodiment of FIG. 4, SSID 3 is a maximum set SSID with length 32 octets. In the embodiment of FIG. 4, in addition to utilizing the data contained in SSID 3, the wireless receiving device 1 may also utilize the data contained in Medium Access Control (MAC) address 4.

In the embodiment of FIG. 4, the wireless receiving device 1 may forward or relay the maximum set SSID 3 and the MAC address 4 received from wireless transmitting device 2 to wireless receiving device 1B. The wireless devices 1 and 1B may communicate according to an 802.11x protocol and may have adopted a further standard or convention that the SSID field is to be used for data other than the identification of the network. In the embodiment of FIG. 4, the wireless receiving device 1B may recognize that the transmitting device 1 has included data other than the identity of the network in the SSID field by the length of SSID 3. In the embodiment of FIG. 4, SSID 3 is a maximum set SSID with length 32 octets. Wireless receiving device 1B having access to the Internet 5 may send received maximum set SSID 3 and MAC address 4 to server 6.

One practical example of the embodiment of FIG. 4 may consist of a wireless transmitting device 2 connected to or a component of a home security alarm. When the home security alarm is activated, the wireless transmitting device 2 may send an 802.11x frame including maximum set SSID 3 and MAC address 4. This information may signal may hop from intermediate wireless receiving device to intermediate wireless receiving device, such as wireless receiving device 1, until it is received by wireless receiving device 1B, and sent over the Internet 5 to Server 6. When Internet access becomes available, the wireless receiving devices can stop transmitting the said signal.

Server 6 may identify the location of the alarm signal using MAC address 4 and content of maximum set SSID 3 and may utilize said content for information such as type of alarm (smoke, burglar, low temperature etc.) and zone of activation. Server 6 may then take the appropriate action as necessary such as alerting resident, police, emergency services etc. The configuration of FIG. 4 allows wireless receiving device 1 and wireless receiving device 1B to form a mesh type network whereby wireless receiving device 1 does not need access to the Internet 5 but relies on wireless receiving device 1B for Internet access.

The wireless system illustrated in FIG. 4 is for explanation, not for limitation. Wireless systems transmitting data other than the identification of the network in a network identification field according to various embodiments of the present invention may operate under protocols other than 802.11x protocols and may indicate that the network identification field contains data in ways other than a maximum set SSID. In some embodiments, for example, the contents of another field or fields of the wireless frame may indicate that the network identification field is used for data other than the identification of the network. In some embodiments, wireless receiving device 1 may relay the data through a network other than the Internet and the recipient of the data may be other than a server. In some embodiments, fields other than the MAC address field may contain information used by wireless receiving device 1. In many embodiments, the signal may hop between many intermediate nodes until it reaches a node connected to a server. In several embodiments, the signal may be modified between receipt by one intermediate wireless receiving device and transmission to the next. In a few embodiments, the signal may be sent over a variety of networks in accordance with a variety of communication protocols.

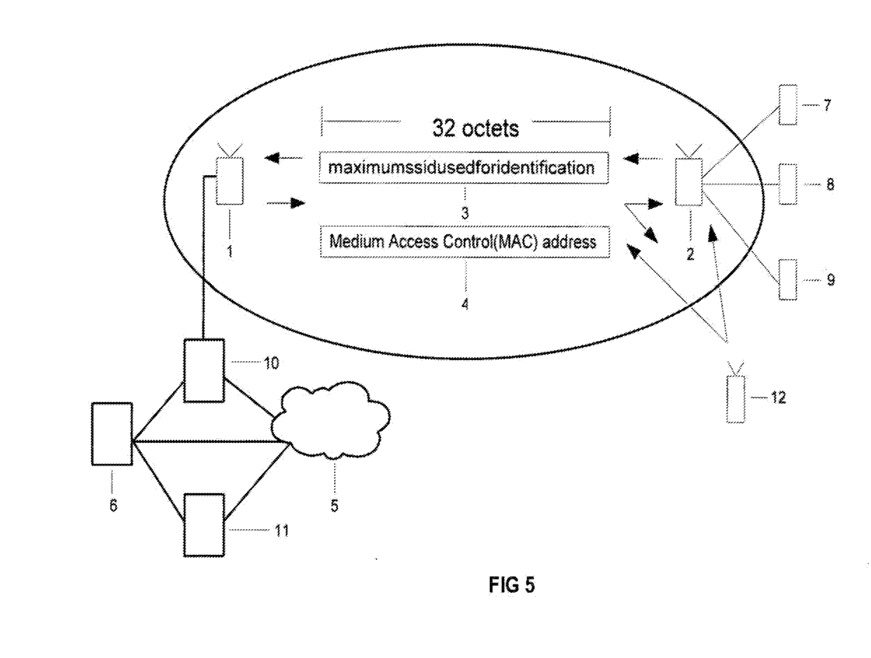

With reference now to FIG. 5, there is shown an additional embodiment of a wireless system for communicating data other than the identification of the network in a network identification field. In the wireless system of FIG. 5, data from end use devices 7, 8, 9, and 12 is relayed through wireless devices 1 and 2 to servers 6, 10, and 11.

End use devices 7, 8, 9, and 12 may include devices such as a home security system, vending machines, utility meters, personal security/health alarms, object/personal locating devices with GPS positioning co-ordinates etc. In this embodiment, the end use devices 7, 8, 9, and 12 may add data content to a maximum length 32 octet SSID field whereby said SSID field contains specific data content regarding one or more of said end use devices such as type of alarm notification, product levels, meter readings, and location coordinates. The end use devices 7, 8, 9, and 12 may transmit the SSID field to wireless device 2 according to an 802.11x protocol. The end use devices 7, 8, 9, and 12 and wireless device 2 may communicate according to an 802.11x protocol and may have adopted a further standard or convention that the SSID field is to be used for data other than the identification of the network. In some embodiments, however, end use devices 7, 8, 9, and 12 may communicate to wireless device 2 through other protocols. For example, some of end use devices 7, 8, 9, and 12 may be connected to wireless device 2 through a wire line or other non-wireless method of communications.

Wireless device 2 may forward or relay data received from the end use devices 7, 8, 9, and 12 to wireless device 1. Wireless devices 1 and 2 may also communicate according to an 802.11x protocol and may have also adopted a further standard or convention that the SSID field is to be used for data other than the identification of the network. The wireless receiving device 1 may receive signals from in-range wireless transmitter 2. In the embodiment of FIG. 5, the wireless receiving device 1 may recognize that the transmitting device 2 has included data other than the identity of the network in the SSID field by the length of SSID 3. In the embodiment of FIG. 5, SSID 3 is a maximum set SSID with length 32 octets. In the embodiment of FIG. 5, in addition to utilizing the data contained in SSID 3, the wireless receiving device 1 also utilizes the data contained in Medium Access Control (MAC) address 4.

The embodiment of FIG. 5 also includes the granting of bi-directional Internet access. Embodiment may enable users at end use devices such as end use devices 7, 8, 9 and 12 to send to and receive from the Internet. The users may, thereby, engage in such applications as VOIP, gaming, instant messaging, video chat, etc. In all of these, servers connected to the Internet may be communicating between the end use device and server

Wireless receiving device 1 may function as an access control device for end use devices 7, 8, 9 and 12, controlling the access of end use devices 7, 8, 9 and 12 to Internet 5. Wireless receiving device 1 may query server 6 over the Internet 5 as to the authorization of end use devices 7, 8, 9 and 12 to access Internet 5 and may identify end use devices 7, 8, 9 and 12 to server 6 through maximum length SSID 3 and the MAC address 4 of end use devices 7, 8, 9 and 12. Server 6 may then process data content specific to the end use devices 7, 8, 9 and 12. As a result, end use devices that may not use WIFI such as a vending machine may be wired to transmitter 2 or an end device may use Bluetooth or other protocol to communicate with transmitter 2 and only receiver 1 has the Internet connection.

In a further embodiment of FIG. 5, one of the end use devices 7, 8, 9 and 12 may have VoIP capabilities. Through the embodiment of FIG. 5, the end use device may be automatically granted access to the Internet 5 once it comes in range of wireless device 2. The end use device may send a frame to wireless device 2 with a maximal set SSID identifying itself. After the contents of the frame are forwarded to server 6, the end use device may be granted access to the Internet and use the access for VoIP. In one example, the end use device may be a mobile device with a VoIP application installed as well as WIFI capabilities. The WIFI application/driver may be set to send a 32 Octet SSID such as a beacon. When the device comes in the vicinity of a receiving device such as wireless device 2, the receiving device may connect the mobile device to the Internet with no input necessary from the mobile device. As a result, the mobile device will automatically be able to use VoIP. Consequently, a user with a WIFI enabled smart phone or other mobile device with a VoIP application installed may use VoIP calling instead of the cellular network by connecting to the Internet through the wireless device 2. Thus, a network of inexpensive receiving devices with Internet access and a presence database could easily provide automatic VoIP coverage using existing devices such as cell phones, tablets etc. In other embodiments, the access to the Internet may be for web browsing, e-mail, instant messaging etc.

FIG. 5 further includes Server 6 having capabilities of forwarding geographical co-ordinates of end use device 7, 8 or 9 obtained from content of maximum set 32 octet SSID and MAC address of said devices to an end user graphical mapping application 10 such as Google maps. An end user application is an application that receives input from a user and provides output to the user.

FIG. 5 may include a presence capability such that server 6 having obtained presence information from maximum set 32 octet SSID and MAC address of end use devices 7, 8, 9 or 12 sends presence information (information about the presence of a person or device at a location) to end user presence capable applications. One practical embodiment of this configuration may consist of a home security alarm transmitting an away status of a home occupant in response to a home security system that has been activated and an available presence when the home alarm system is deactivated. Server 6 sends said content information to a VoIP based end user application such that the end user application 11 is continually aware of the presence of the home occupant without the home occupant manually activating presence status. This would be especially useful for parents to monitor children's presence in the home.

In other embodiments of FIG. 5, wireless transmitting device 2 and end use device 7, 8, 9 and 12 may be a mobile device such as a cell phone, PDA, GPS etc. These embodiments may allow for mobile presence and/or location of persons or objects. For example, an 802.11x enabled cell phone 12 or PDA 12 may transmit a maximum set 32 octet SSID containing identification information of the owner of the device whenever said cell phone 12 or PDA 12 is in range of disclosed wireless receiving device 2. Wireless receiving device 2 may send said identification information to Server 6 and further to graphical mapping application 10 or presence application 11 by relaying it through wireless receiving device 2.

In still other embodiments of FIG. 5, the configuration may provide location information about end users. For example, end use device 12 may constitute a mobile device 12 such as a cell phone. When end use device 12 transmits a maximum set SSID and MAC address to wireless device 1, then the next fixed placed wireless device such as the wireless transmitter 2 or the wireless receiving device 1 may send its own MAC address thereby allowing very close approximation of the location of end use device 12. This embodiment may enable parents to locate children with cell phones, PDA's etc. It also may enable the locating of vehicles, objects etc. In an alternate embodiment, the mobile end use device 12 may comprise an anklet augmented with a transmitter. This embodiment may enable the locating of a person under supervision, such as a criminal on parole or a released sex offender.

The wireless system illustrated in FIG. 5 is for explanation, not for limitation. Wireless systems transmitting data other than the identification of the network in a network identification field according to various embodiments of the present invention may operate under protocols other than 802.11x protocols and may indicate that the network identification field contains data in ways other than a maximum set SSID. In further embodiments, some of the transmissions may be according to one protocol, and other transmissions may be according to another protocol. For example, an end use device may transmit data to wireless receiving device 2 under one protocol and wireless receiving device 2 may in turn transmit data to wireless device 1 under another protocol. In some embodiments, for example, the contents of another field or fields of the wireless frame may indicate that the network identification field is used for data other than the identification of the network. In some embodiments, some of the end use devices may transmit to wireless device 2 under different protocols than other devices. For example, end use device 7 may transmit data to wireless device 2 with a length of n₁ octets and end use device 8 may transmit data to wireless device 2 with a length of n₂ octets. Wireless device 2 may recognize the two SSID lengths as both indicating that the SSID contains data other than a network identification.

In some embodiments, wireless receiving device 1 may relay the data through a network other than the Internet and the recipient of the data may be other than a server. In some embodiments, fields other than the MAC address field may contain information used by wireless receiving device 1. In many embodiments, the signal may hop between many intermediate nodes until it reaches a node connected to a server. In several embodiments, the signal may be modified between receipt by one intermediate wireless receiving device and transmission to the next. In a few embodiments, the signal may be sent over a variety of networks in accordance with a variety of communication protocols. In some embodiments, wireless receiving device 2 may connect to a different number of end use devices than the number depicted in FIG. 5. In some embodiments, the signal from the end use devices to the servers may pass through more intermediate devices than in the embodiment of FIG. 5.

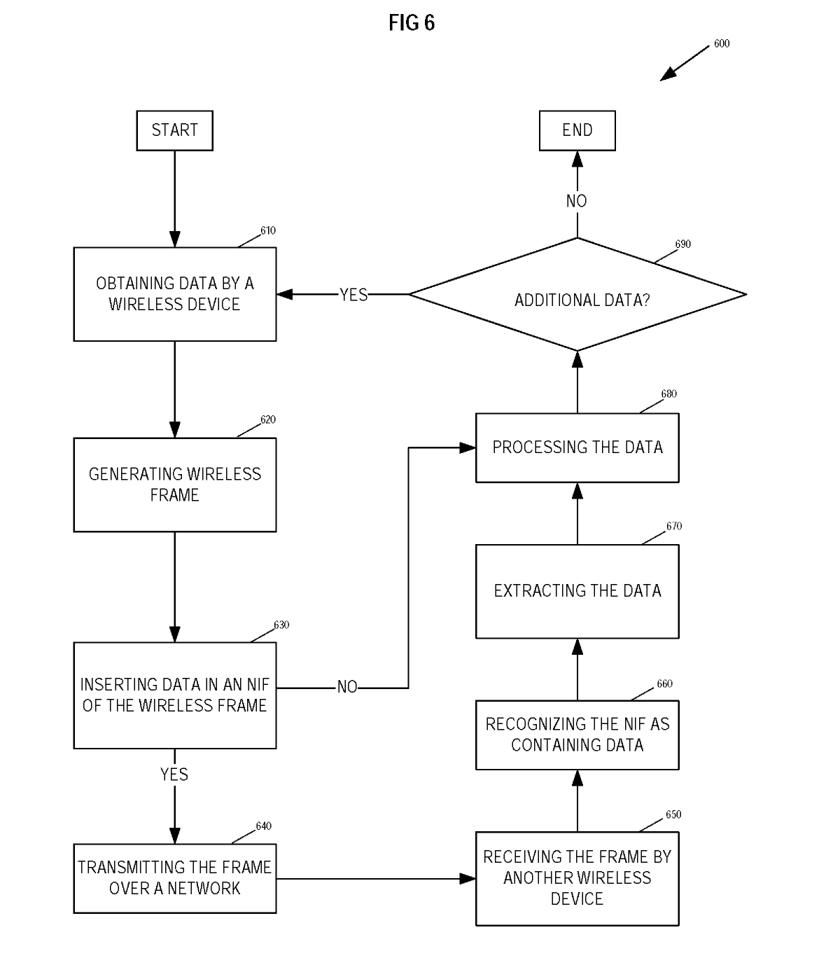

FIG. 6 describes a flowchart of an embodiment to for transmitting data in an identification field of a wireless frame. Flow chart 600 begins with a wireless transmitting device obtaining data (element 610) directly through sensors or other components, by reading it from memory, or by receiving data from another device. The wireless transmitting device may generate a wireless frame (element 620), place a representation of the data in the network identification field of the wireless frame (element 630), and transmit the wireless frame to a wireless receiving device over a wireless network (element 640). The wireless receiving device may receive the wireless frame (element 650), recognize the network identification field as containing data (element 660), extract the data (element 670) and process the data (element 680). The processing may include forwarding the data to another device, either over the same wireless network or another network. In many embodiments, the other network may be the Internet. The devices may check if there is additional data to be sent (element 390). If not, dynamic activation of the processor may end.

If so, each element from 610 to 680 may be repeated. In further embodiments, the wireless transmitting device and wireless receiving device may communicate under a protocol which provides for a variable length network identification field. The wireless transmitting device and wireless receiving device may operate according to a protocol or standard under which a network identification field of a particular length signals that the field is used to transmit data. In further embodiments, the network identification field may consist of the SSID of a transmission according to an 802.11x protocol.

Some embodiments of this invention may provide a useful improvement to the WLAN functionality. They may provides messaging, notifications and/or network access to STA's on a predetermined basis such that an IEEE 802.11x compliant STA device may be used for a multitude of useful alternative functions such as home/commercial security alarms, personal safety/health devices, personal/object locating, presence, instant messaging, web access, VoIP, utility meter reading, product level tracking such as vending machines, etc. In some further, embodiments, a STA device described herein may require only the ability to send a probe request or beacon signal with a SSID according to IEEE 802.11x protocol to function with the disclosed invention.

Presently many of the described alternative functions depend on cellular (telemetry) or radio technologies (telemetry). These technologies may depend on costly cellular or radio devices as well as a closed cellular/radio infrastructure which in most instances have access and usage fees that are high and sometimes cost prohibiting. Some embodiments of this invention may provide a low cost, widely accessible alternative to the cellular or present radio infrastructure for messaging and access control.

Another embodiment is implemented is implemented as a program product for implementing systems and methods described with reference to FIGS. 1-6. Embodiments can take the form of an entirely hardware embodiment, an entirely software embodiment, or an embodiment containing both hardware and software elements. One embodiment is implemented in software, which includes but is not limited to firmware, resident software, microcode, etc.

Furthermore, embodiments can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device.

The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

A data processing system suitable for storing and/or executing program code will include at least one processor coupled directly or indirectly to memory elements through a system bus or other architecture. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, touch screens, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem, and Ethernet adapter cards are just a few of the currently available types of network adapters.

The logic as described above may be part of the design for an integrated circuit chip. The chip design may be created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It will be apparent to those skilled in the art having the benefit of this disclosure that the present disclosure contemplates wireless network notification messaging and access devices. It is understood that the form of the embodiments shown and described in the detailed description and the drawings are to be taken merely as examples. It is intended that the following claims be interpreted broadly to embrace all variations of the example embodiments disclosed.

Although the present disclosure has been described in detail for some embodiments, it should be understood that various changes, substitutions, and alterations can be made herein without departing from the spirit and scope of the disclosure as defined by the appended claims. Although specific embodiments may achieve multiple objectives, not every embodiment falling within the scope of the attached claims will achieve every objective. Moreover, the scope of the present application is not intended to be limited to the particular embodiments of the process, machine, manufacture, composition of matter, means, methods, and steps described in the specification. As one of ordinary skill in the art will readily appreciate from this disclosure, processes, machines, manufacture, compositions of matter, means, methods, or steps presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A wireless receiving device to:
receive from a wireless transmitting device through a network a frame of a wireless transmission pursuant to a network protocol providing a network identification field (NIF);
determine on the basis of one or more values of fields of the frame that data other than an identification of the network is contained in the NIF of the frame; and
extract data other than an identification of the network from the NIF of the frame.

2. The wireless receiving device of claim 1, wherein:
the network protocol provides for a variable-length NIF;
the determining comprises determining that the NIF of the frame is of length n, wherein n is a positive integer and a standard for transmission under the network protocol provides that an NIF field of length n contains data other than an identification of a network.

3. The wireless receiving device of claim 2, wherein the NIF comprises a Service Set Identifier (SSID) described by an IEEE 802.11x protocol.

4. The wireless receiving device of claim 1, wherein the determining comprises determining that the NIF frame contains data other than an identification of the network on the basis of values of one or more fields of the frame other than the NIF.

5. The wireless receiving device of claim 1, wherein the wireless receiving device is further to authenticate a sender of the transmission based upon the data extracted from the NIF of the frame.

6. The wireless receiving device of claim 5, wherein the wireless receiving device is further to authenticate the sender of the transmission based upon a MAC address contained in the frame.

7. The wireless receiving device of claim 5, wherein the wireless receiving device is further to grant the sender of the transmission access to another network based upon the authentication.

8. The wireless receiving device of claim 7, wherein the grant comprises granting access to the Internet.

9. The wireless receiving device of claim 8, wherein the wireless receiving device is to provide the wireless transmitting device access to a VoIP application on the Internet.

10. The wireless receiving device of claim 5, wherein the wireless receiving device is further to activate a device based upon the authentication.

11. The wireless receiving device of claim 12, wherein:
the wireless device is to monitor for transmissions under the network protocol; and the wireless device is not to send transmissions, other than transmissions to a device to control the operation of the device.

12. The wireless receiving device of claim 1, wherein the wireless receiving device is to relay contents of the frame, the contents comprising the NIF, to a similar in range wireless receiving device, thereby providing a mesh network environment to the wireless transmitting device.

13. The wireless receiving device of claim 1, the wireless receiving device comprising a wireless access point and/or a wireless router.

14. The wireless receiving device of claim 1, wherein the extracting comprises extracting presence status data from the NIF and/or from the MAC address of the wireless transmitting device, the presence status data comprising data indicating the presence of a person or a device at a particular location.

15. The wireless receiving device of claim 1, wherein the wireless receiving device is further to:
recognize the wireless transmitting device as a mobile device;
contact a fixed location wireless device to obtain a location mapping of said mobile device; and
set a location identification of the wireless transmitting device to correspond to the fixed location wireless device.

16. A wireless transmitting device to:
generate a frame for a wireless transmission pursuant to a network protocol providing for a network identification field (NIF);
encode data in the NIF of the frame;
insert in the frame an indication that data is encoded in the NIF of the frame, the indication comprising one or more values of fields of the frame; and
transmit the frame in a wireless communication over a wireless network according to the network protocol, wherein the encoded data is other than an identification of the wireless network.

17. The wireless transmitting device of claim 16, wherein:
the network protocol provides for a variable-length NIF;
a standard for transmission under the network protocol provides that an NIF field of length n contains data other than an identification of a network, wherein n is a positive integer; and
the inserting the indication comprises inserting in the frame an NIF of length n.

18. The wireless transmitting device of claim 18, wherein:
the network protocol is an 802.11x protocol; and
the NIF comprises a Service Set Identifier (SSID) described by an IEEE 802.11x protocol.

19. The wireless transmitting device of claim 1, wherein the inserting comprises inserting in the frame values of one or more fields of the frame other than the NIF to indicate that the frame contains non-network information in the NIF.

20. The wireless transmitting device of claim 16, wherein the data encoded in the NIF of the frame comprises one or more elements selected from the group consisting of:
a security key;
identification data about an identify of a person or a device transmitting the frame;
monitoring data about the state of a device or environment, the monitoring data comprising:
product levels;
meter readings;
a type of alarm notification; or
a zone of activation of an alarm;
geographical or location information about a location of a person or device transmitting the frame;
presence information about whether an occupant is present in a building.

21. The wireless transmitting device of claim 16, coupled to an ankle tether, wherein the data comprises an identification of a person wearing the ankle tether.

22. The wireless transmitting device of claim 16, wherein the frame is to include a MAC address of the wireless transmitting device.

23. The wireless transmitting device of claim 16, wherein said frame comprises a probe request/response frame or beacon frame described by an IEEE 802.11x protocol and said transmitting comprises transmitting a request/response signal or beacon signal described by an IEEE 802.11x protocol

24. The wireless transmitting device of claim 23, wherein the wireless transmitting device:
is to receive monitoring data from one or more sensors;
transmit only an IEEE 802.11x probe request/response signal or an IEEE 802.11x beacon signal, wherein the monitoring data is encoded in the SSIDs of the signals; and
the wireless transmitting device is to connect to other transmitters of IEEE 802.11x signals.

25. A method of wireless communications, the method comprising:
generating a frame for a wireless transmission pursuant to a network protocol providing a network identification field (NIF);
encoding data in the NIF of the frame;
inserting in the frame an indication that data is encoded in the NIF of the frame, the indication comprising the values of one or more fields of the frame; and
transmitting the frame in a wireless communication over a wireless network according to the network protocol, wherein the data encoded in the NIF is other than an identification of the wireless network.
